(19) United States
(12) Patent Application Publication
(10) Pub. No.: US 2013/0073816 A1
(43) Pub. Date: Mar. 21, 2013

(54) METHOD OF STORING DATA IN A STORAGE MEDIUM AND DATA STORAGE DEVICE INCLUDING THE STORAGE MEDIUM

(71) Applicants: Mankeun SEO, Hwaseong-si (KR); Junjin KONG, Yongin-si (KR)

(72) Inventors: Mankeun SEO, Hwaseong-si (KR); Junjin KONG, Yongin-si (KR)

(73) Assignee: SAMSUNG ELECTRONICS CO.,LTD., Suwon-si (KR)

(21) Appl. No.: 13/615,752

(22) Filed: Sep. 14, 2012

(30) Foreign Application Priority Data
Sep. 19, 2011 (KR) 10-2011-0094244

(51) Int. Cl. G06F 12/00

(52) U.S. Cl. 711/154; 711/E12.001

(57) ABSTRACT

A method of storing data in a storage medium and a data storage device including the storage medium are provided. The method of storing data in accordance with exemplary embodiments of the inventive concept may include receiving data to be stored in the storage medium; determining whether the received data is user data or metadata used to manage the user data; and selectively compressing the received data according to a type of the determined data. Selectively compressed data is stored in the storage medium.

### CROSS-REFERENCE TO RELATED APPLICATIONS

This U.S. non-provisional patent application claims priority under 35 U.S.C. §119 from Korean Patent Application No. 10-2011-0094244, filed on Sep. 19, 2011, the entire contents of which are hereby incorporated herein by reference.

### BACKGROUND

The present inventive concept herein relates to methods of storing data in a storage media, and more particularly, to a data storage device including the storage media.

A computer system uses various types of storage devices. For example, a computer system uses a main memory formed of semiconductor devices. A random access memory (RAM) randomly read or written at high access speed maybe used as a main memory.

However, since a random access memory is comparatively expensive, a low price memory having high density is often used. For example, a hard disk drive (HDD) and a solid state disk (SSD) are used. Unlike a hard disk drive (HDD) which usually uses comprises magnetic disks and moving parts, a solid state disk (SSD) is a data storage device which uses integrated circuits and non-moving parts when storing data.

If compression is performed before data is stored in a storage device, a storage area of storage device may be effectively used. If compression is performed, the number of data reads and data writes may be reduced and thereby the life of the storage device may increase.

### SUMMARY

According to an aspect of an exemplary embodiment, a method of storing data includes: receiving data to be stored in the storage medium; determining whether the received data is user data or metadata used to manage the user data; selectively compressing the received data according to a type of the determined data; and storing the selectively compressed data in the storage medium.

According to another aspect of an exemplary embodiment a data storage device includes: a storage medium; and a controller configured to selectively compress received data and store the selectively compressed data in the storage medium. The controller is configured to determine whether the received data is user data or metadata used to manage the user data and selectively compress the received data according to the determined type.

### BRIEF DESCRIPTION OF THE FIGURES

Exemplary embodiments of the inventive concept will be described below in more detail with reference to the accompanying drawings. The exemplary embodiments of the inventive concept may, however, be embodied in different forms and should not be constructed as limited to the exemplary embodiments set forth herein. Rather, these exemplary embodiments are provided so that this disclosure will be thorough and complete, and will fully convey the scope of the inventive concept to those skilled in the art. Like numbers refer to like elements throughout.

FIG. 1 is a block diagram illustrating the arrangement of software on a computing system.

FIG. 2 is a block diagram illustrating a data storage device according to an aspect of an exemplary embodiment.

FIG. 3 is a block diagram illustrating a controller of FIG. 2 according to an aspect of an exemplary embodiment.

FIG. 4 is a flow chart illustrating a data storage method of data storage device of FIG. 2 according to an aspect of an exemplary embodiment.

FIG. 5 shows the total space of logic addresses received from a host according to an aspect of an exemplary embodiment.

FIG. 6 is a flow chart showing steps of S130 and S140 of FIG. 4 according to an aspect of an exemplary embodiment.

FIG. 7 is a drawing showing a data flow in accordance with a write method of FIGS. 4 and 6 according to an aspect of an exemplary embodiment.

FIG. 8 is a flow chart showing steps of S130 and S140 of FIG. 4 according to another aspect of an exemplary embodiment.

FIG. 9 is a block diagram showing a nonvolatile memory as storage media of FIG. 2 according to an aspect of an exemplary embodiment.

FIGS. 10 and 11 are drawings for describing a method of storing data processed by a controller in a nonvolatile memory according to an aspect of an exemplary embodiment.

FIG. 12 is a block diagram showing an application example of data storage device according to an aspect of an exemplary embodiment.

FIG. 13 is a block diagram showing a computing system including the data storage device described with reference to FIG. 12 according to an aspect of an exemplary embodiment.

### DETAILED DESCRIPTION OF EXEMPLARY EMBODIMENTS

Exemplary embodiments of the inventive concept will be described more fully hereinafter with reference to the accompanying drawings, in which exemplary embodiments are illustrated. This inventive concept may, however, be embodied in many different forms and should not be construed as limited to the exemplary embodiments set forth herein. Rather, the exemplary embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

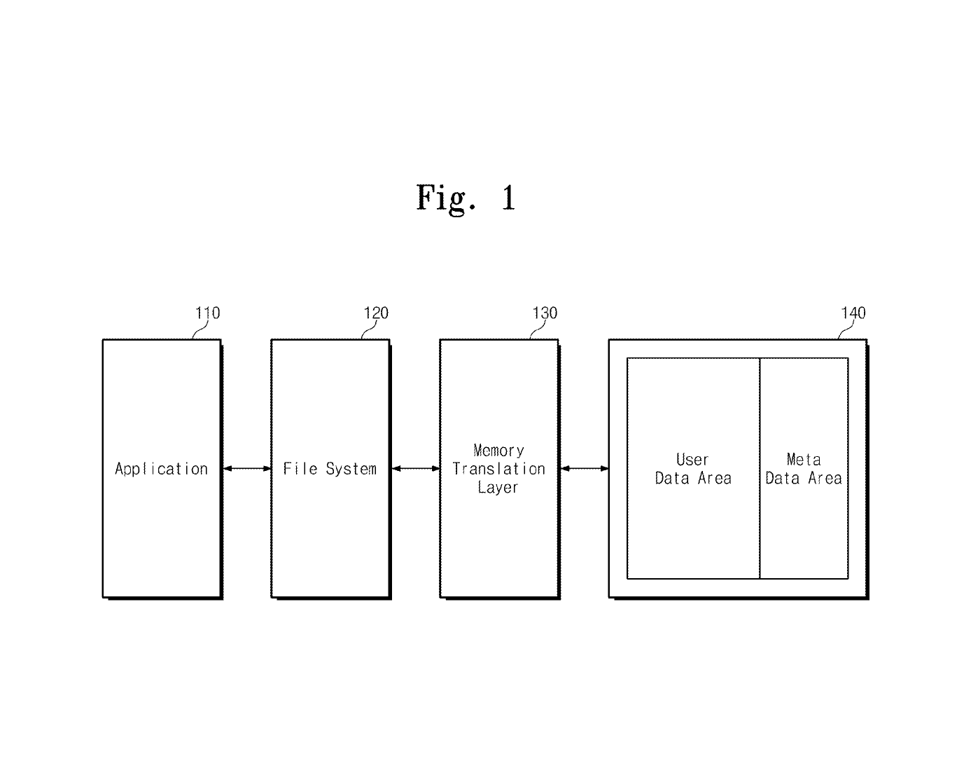

FIG. 1 is a block diagram illustrating the arrangement of software on a computing system. Referring to FIG. 1, a software arrangement includes an application 110, a file system 120, a memory translation layer 130 and a storage media 140.

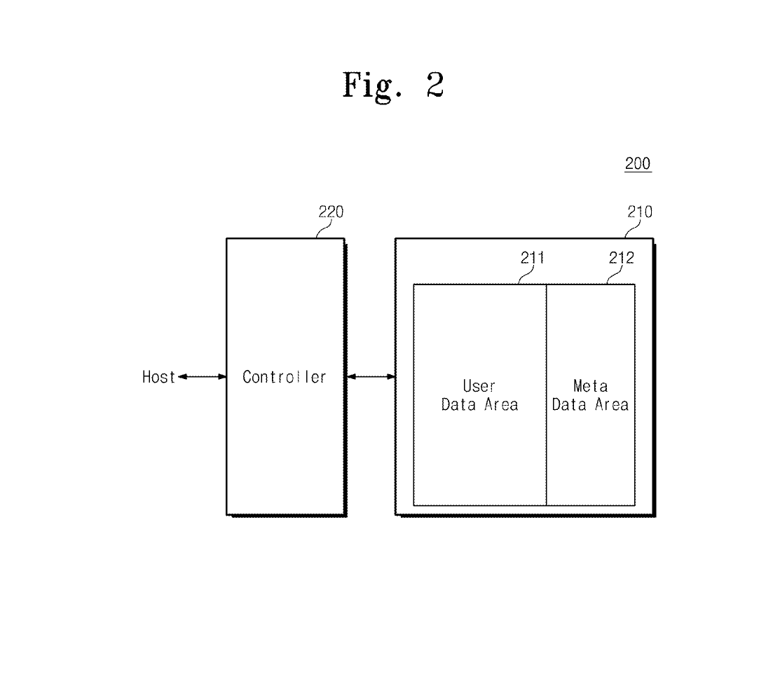

The file system 120 receives a command from the application 110. A command from the application 110 may include a data storage command, a data read command, a data move command, a data delete command and a data recovery command. The file system 120 transmits a logical address of data requested according to the command from the application 110 to the memory translation layer 130. For example, the application 110 and the file system 120 may be operated by a host of FIG. 2.

The requested data may be one of user data and metadata. User data and the metadata describe a type of data to be processed. The user data may include text data, image data, voice data and software data. The user data is data generated by a user. The metadata is data for managing user data. For example, the metadata may include location information in which user data is stored. The metadata may be generated by the file system 120.

The memory translation layer 130 receives a logical address from the file system 120. The memory translation layer 130 translates a logical address into a physical address. The memory translation layer 130 translates a logical address into a physical address with reference to mapping information included therein. The mapping information defines a corresponding relation between the logic address and the physical address. The translated physical address is provided to the storage media 140.

The storage media 140 includes a user data area and a metadata area. The user data area and the metadata area may be physically divided. The user data area and the metadata area may be conceptually distinct from each other.

The memory translation layer 130 may determine whether the requested data is user data or metadata. The memory translation layer 130 determines whether the requested data is user data or metadata according to a logical address being received from the file system 120.

When a write operation is performed, the memory translation layer 130 generates a physical address so that user data is stored in a user data area and metadata is stored in a metadata area. The storage media 140 stores the requested data in a user data area or a metadata area according to a physical address from the memory translation layer 130.

When a read operation is performed, the memory translation layer 130 translates a logical address from the file system 120 into a physical address and provides the translated physical address to the storage media 140. The memory translation layer 130 receives data corresponding to the physical address from the storage media 140 and provides the received data to the file system 120.

The file system 120 catches a storage location (for example, information on a logical address corresponding to user data) of user data with reference to metadata of a metadata area.

FIG. 2 is a block diagram illustrating a data storage device in accordance with an aspect of an exemplary embodiment. Referring to FIG. 2, the data storage device 200 includes a storage media 210 and a controller 220.

The storage media 210 operates in response to a control of the controller 220. The storage media 210 includes a user data area 211 and a metadata area 212. As described in FIG. 1, user data is stored in the user data area 211 and metadata is stored in the metadata area 212.

The storage media 210 may be formed of nonvolatile memories such as a NAND flash memory, a NOR flash memory, a phase change memory (PRAM), a ferroelectric memory (FeRAM), a magnetic RAM (MRAM), etc. The storage media 210 may be formed of a hard disk drive. However, the storage media 210 may not be limited to those disclosed in exemplary embodiments of the inventive concept.

The controller 220 controls the storage media 210 in response to a request from a host. The application 110 and the file system 120 illustrated in FIG. 1 may be operated by the host. The memory translation layer 130 of FIG. 1 is operated by the controller 220.

When a write operation is requested, the controller 220 determines whether data received from the host is user data or metadata. If data from the host is determined to be user data, the controller 220 compresses the received data and stores the compressed data in the storage media 210. If data from the host is determined to be metadata, the controller 220 does not compress the received data and stores raw data (or data that is not compressed) in the storage media 210.

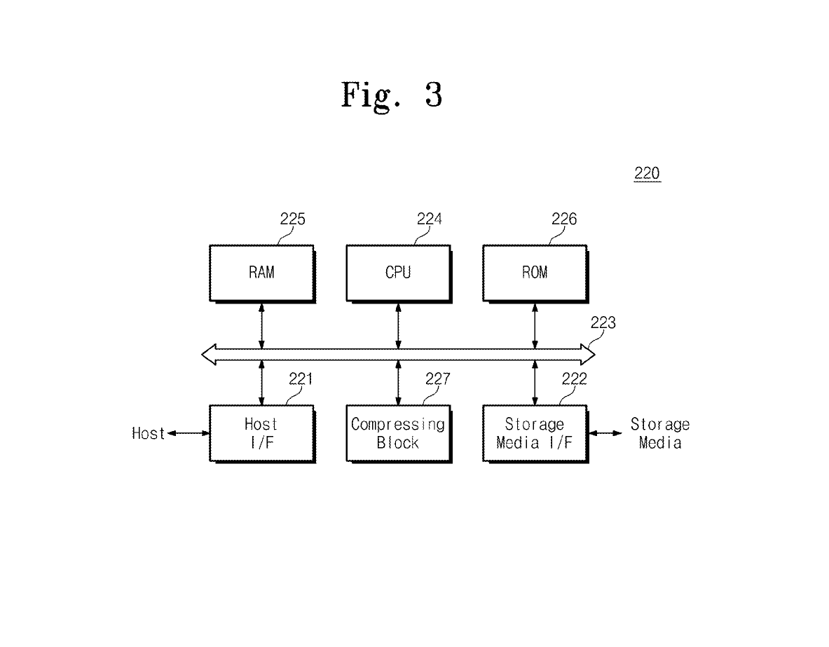

FIG. 3 is a block diagram illustrating a controller of FIG. 2. Referring to FIG. 3, the controller 220 includes a host interface 221, a storage media interface 222, a bus 223, a central processing unit (CPU) 224, a RAM 225, a ROM 226 and a compressing block 227.

The host interface 221 is configured to interface with a host. The host interface 221 includes a protocol to perform a data exchange between the host and the memory controller 220. The host interface 221 is configured to communicate with the external (host) through at least one of various interface protocols such as a universal serial bus (USB) protocol, a multimedia card (MMC) protocol, a peripheral component interconnection (PCI) protocol, a PCI-express protocol, an advanced technology attachment (ATA) protocol, a serial-ATA protocol, a parallel-ATA protocol, a small computer small interface (SCSI) protocol, an enhanced small disk interface (ESDI) protocol and an integrated drive electronics (IDE) protocol. The host interface 221 may also be formed of a proprietary interface that is not one of the protocols described above used to communicate with the host. For example, the host interface 221 may be located on an exterior of the controller 220.

The storage media interface 222 is configured to interface with the storage media 210 of FIG. 2. In the case that the storage media 210 is a nonvolatile memory, the storage media interface 222 includes a NAND interface or a NOR interface.

The bus 223 provides a channel to connect at least two of the storage media interface 222, the central processing device 224, the RAM 225, the ROM 226 and the compressing block 227.

The central processing unit 224 (CPU) controls the overall operation of the controller 220. The CPU 224 operates firmware (or software) such as a memory translation layer stored in the ROM 226. The ROM 226 illustrated in FIG. 3 may be replaced with another device that can store firmware. For example, the ROM 226 may be replaced with a nonvolatile memory.

The memory translation layer may be used to manage mapping information. The CPU 224 provides a physical address corresponding to a logical address from the host by operating the memory translation layer. That is, the CPU 224 translates a logical address received from the host into a physical address and provides the translated physical address to the storage media 210.

In the case that the storage media 210 is a flash memory, the memory translation layer may be a flash translation layer (FTL). The flash translation layer (FTL) may be used to manage a wear-leveling management of the storage media 210, a bad block management, and a data preservation management due to an unexpected power off.

The CPU 224 temporally stores data received from the host in the RAM 225. The CPU 224 determines a type of the received data. That is, the CPU 224 determines whether the received data is user data or metadata. If the received data is user data, the CPU 224 controls the compressing block 227 to compress the received data. If the received data is metadata, a compressing operation is not performed on the received data.

In the cast that the data received from the host is user data, the CPU 224 divides the received data into random data and sequential data. The sequential data describes data having a comparatively high sequentiality or data that is stored in a sequentially ordered blocks and the random data means data having sequentiality lower than that of the sequential data or data that is stored in randomly ordered blocks.

The CPU 224 determines a chunk to compress random data and sequential data. That is, the random data and the sequential data are each compressed by a different chunk size. The chunk describes a compression unit of when a compression operation is performed on raw data.

The CPU 224 controls the compressing block 227 to compress random data and sequential data according to the determined chunk. The CPU 224 provides the determined chunk value to the compressing block 227.

The RAM 225 may be used as an operation memory of the CPU 224. Also, the RAM 225 may be used as a buffer memory between the host and the storage media 210. For example, the RAM 225 temporally stores data being received from the host through the host interface 221. The RAM 225 temporally stores data being received from the storage media 210 through the storage media interface 222.

The compressing block 227 compresses data determined to be user data stored in the RAM 225 in response to a control of the CPU 224. The compressing block 227 compresses user data determined to be random data or sequential data according to a chunk value being received from the CPU 224. According to a control of the CPU 224, random data and sequential data may be compressed by different chunk units respectively.

The compressed data may be temporally stored in the compressing block 227 or stored in the RAM 225. The compressed data may be stored in the storage media 210 through the storage media interface 222. Information about a chunk value may be stored in the storage media 210 together with the compressed data. When a read operation is performed on the compressed data, the compressed data and information about the chunk value may be read from the storage media 210. The CPU 224 controls the compressing block 227 according to the information about the chunk value so that the compressed data is decompressed.

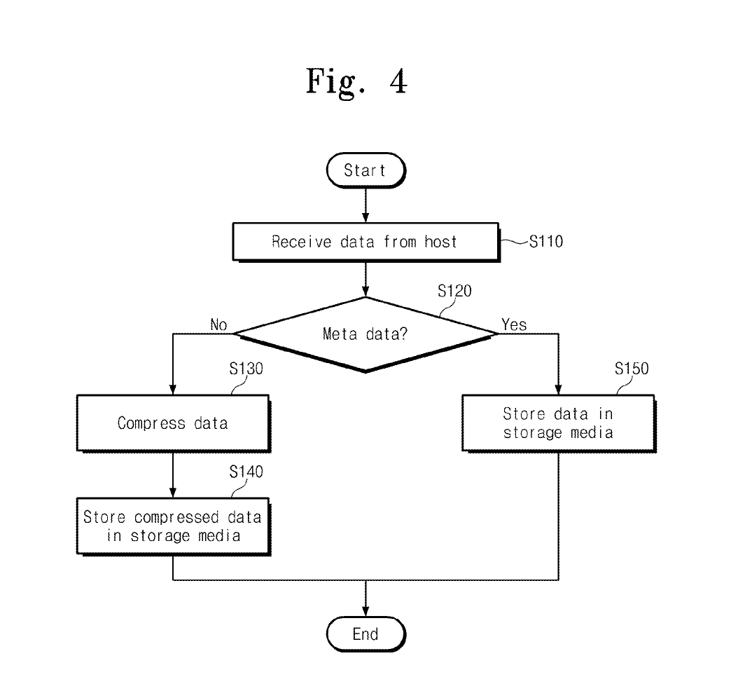

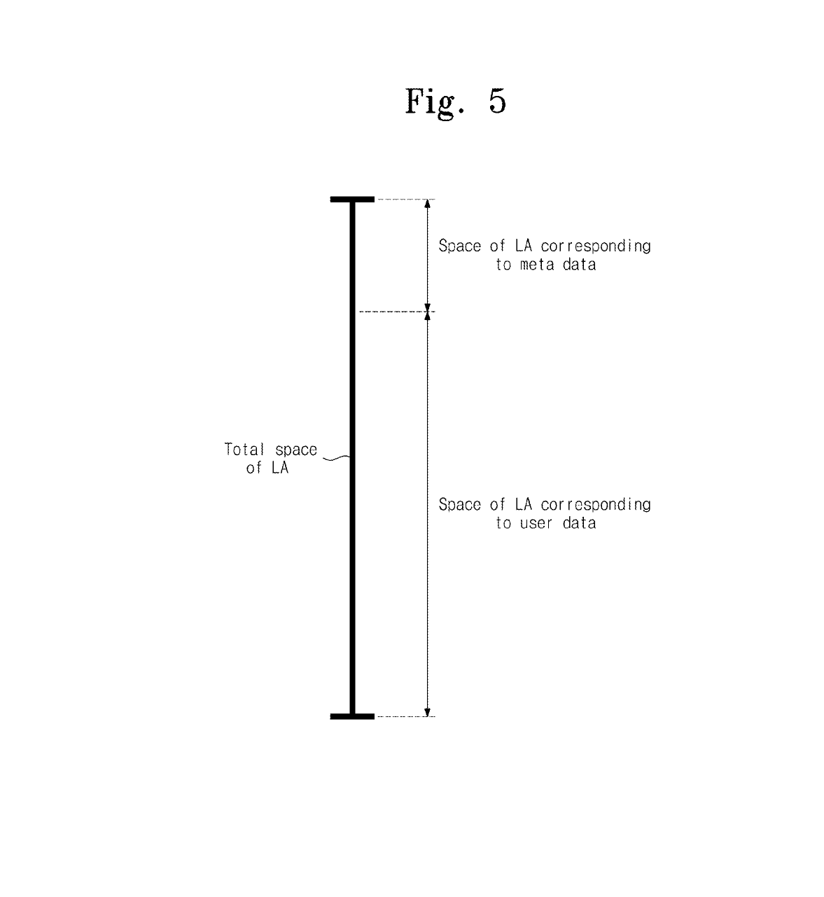

FIG. 4 is a flow chart illustrating a data storage method of data storage device 200 of FIG. 2. FIG. 5 shows the total space of logic addresses received from a host.

Referring to FIGS. 2, 3 and 4, in step S110, the controller 220 receives data from the host. The controller 220 may receive a logical address corresponding to the data from the host together with the data from the host.

In step S120, the central processing unit (CPU) 224 determines a type of the received data. The CPU 224 may determine whether the received data is user data or metadata.

Referring to FIG. 5, total space of logical address LA received from the host may be divided into a space of logical address corresponding to metadata and a space of logical address corresponding to user data. When a write operation on metadata is requested, a logical address may be provided which particularly assigns an area that belongs to a space of logical address corresponding to metadata. When a write operation on user data is requested, a logical address may be provided which particularly assigns an area that belongs to a space of logical address corresponding to user data. That is, whether the received data is metadata or user data may be determined depending on which group between two groups the logical address LA received from the host is included in.

The CPU 224 determines whether the data received together with logical address is user data or metadata on the basis of the logical address received from the host when a write operation is requested. A method of determining whether the data from the host is user data or metadata may not be limited to that described above.

Referring back to FIG. 4, in the case that data received from the host is user data, step S130 is executed. In the case that data received from the host is metadata, step S150 is executed.

In step S130, the central processing unit (CPU) 224 controls the compressing block 227 to compress the data received from the host. In step S140, the CPU 224 stores the compressed data in the storage media 210.

In the case that the data received from the host is metadata, the data is not compressed. In step S150, the CPU 224 stores the data received from the host in the storage media 210 without compression.

An effective use of the storage media 210 may be possible by applying a data compression method. For example, it is possible to store much more data in a space of fixed size.

When compressed data is stored in the storage media 210 and an access request for the compressed data is received, a decompressing operation is required. For example, when compressed data stored in the storage media 210 is updated, the compressed data is read and the read data is decompressed. And then, an update is performed on the decompressed data. After the updated data is compressed, the compressed data is stored in the storage media 210 again. Metadata is more frequently accessed than user data. Metadata is quickly accessed by not compressing metadata more frequently accessed than user data. Consequently, an operation speed of the data storage device 200 and an operation speed of the host connected to the data storage device 200 may be improved.

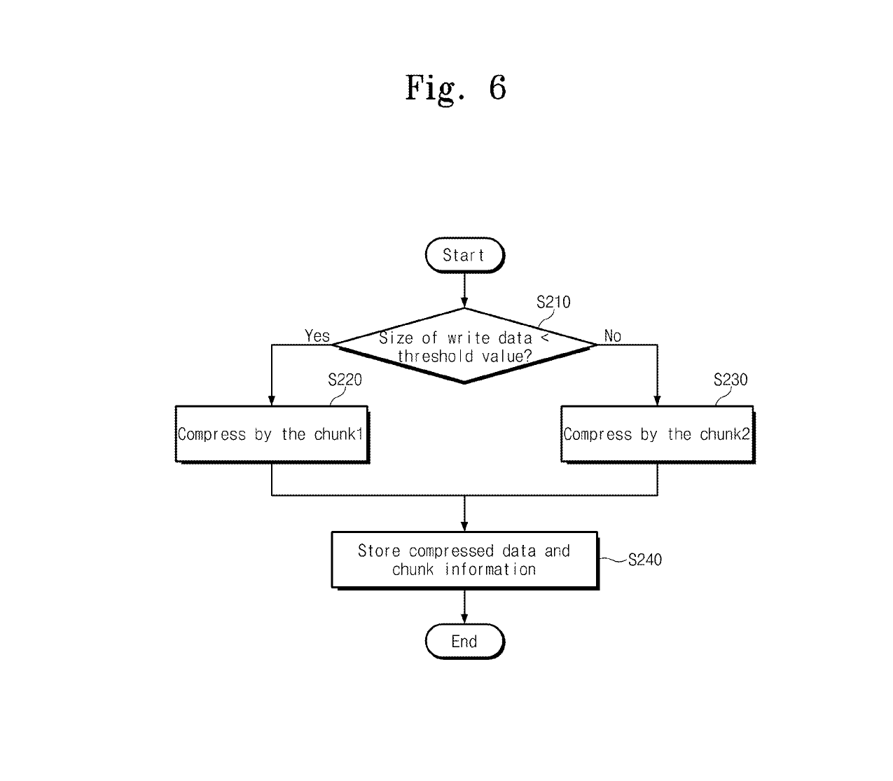

FIG. 6 is a flow chart showing an embodiment of steps of S130 and S140 of FIG. 4. Referring to FIGS. 2, 3 and 6, in step S210, the CPU 224 compares a size of write unit with a threshold value.

Data received from the host may be divided into a plurality of write units according to sequentiality of logical address areas or a number of sequential address blocks that correspond to the received data. One write unit may correspond to a logical address indicating an area having sequentially increasing values or sequentially decreasing values. A write unit means data being received when one write operation is requested from the host. In an example, when a write operation is requested, together with data to be stored, information of a beginning value of a logical address and a size of logical address are provided from the host, so that an area indicated by the logical address may be specified. A beginning sector of a logical address and the number of the sectors are provided, so that an area indicated by the logical address may be specified. In another example, when a write operation is requested, together with data to be stored, information of a beginning value of logical address and an ending value of logical address are provided from the host, so that an area indicated by the logical address may be specified. Logical address values included in an area indicated by each logical address may be sequentially arranged.

A size of write unit may be determined by a logical address corresponding to the write unit. For example, when information of a beginning value of logical address and a size of logical address are received from the host, a size of the write unit may be determined according to size information of the logical address.

Whether a write unit is random data or sequential data may be determined by comparing a size of a write unit with a threshold value. When a size of write unit is greater than the threshold value the sequentiality of a write unit is high. When a size of a write unit is smaller than the threshold value, the sequentiality of the write unit is low.

When a size of a write unit is smaller than the threshold value, the write unit may be determined to be a random unit. When a size of a write unit is equal to or greater than the threshold value, the write unit may be determined to be sequential data. When a size of a write unit is smaller than the threshold value, step S220 is executed. When a size of a write unit is equal to or greater than the threshold value, step S230 is executed.

In the step S220, write units determined to be random data are compressed by a first chunk unit. The CPU 224 controls the compressing block 227 so that write units determined to be random data are compressed by a first chunk unit.

In the step S230, write units determined to be sequential data are compressed by a second chunk unit. The CPU 224 controls the compressing block 227 so that write units determined to be sequential data are compressed by a second chunk unit.

A size of the first chunk is smaller than a size of the second chunk. That is, a size of a chunk corresponding to data determined to be random data is smaller than a size of a chunk corresponding to data determined to be sequential data.

In step S240, the CPU 224 stores chunk information in the storage media 210 together with the compressed data. Since a compression operation is performed by the first chunk unit or the second chunk unit, chunk information for determining a chunk unit of the compressed data when executing a decompressing operation is stored in the storage media 210.

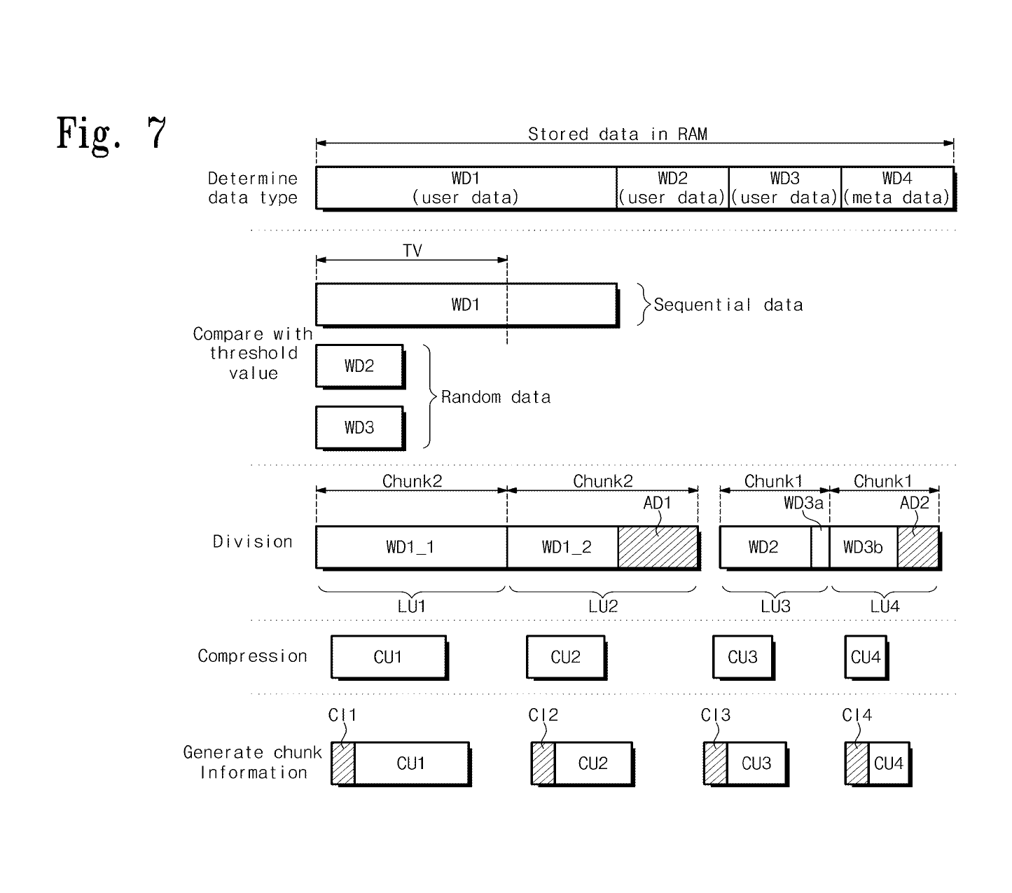

FIG. 7 is a drawing showing a data flow in accordance with a write method of FIGS. 4 and 6. Referring to FIGS. 2, 3 and 7, data being received from the host is stored in the RAM 225. When a plurality of write operations are requested, units WD1-WD4 being received respectively are stored in the RAM 225.

First, a type of write unit stored in the RAM 225 is determined (refer to the step S120 of FIG. 4). Each write unit may be determined to be metadata or user data. As an illustration, the CPU 224 may determine a type of each write unit on the basis of a logical address received together with each write unit. In FIG. 7, the first through third write units WD1-WD3 are assumed to be user data. The fourth write unit WD4 is assumed to be metadata.

According to an aspect of an exemplary embodiment, a compression operation is not executed on the fourth write unit WD4. The first through third write units WD1-WD3 are compressed.

The CPU 224 compares sizes of the first through third write units WD1-WD3 with the threshold value and divides the first through third write units WD1-WD3 into sequential data and random data. The first write unit WD1 having a size greater than the threshold value may be determined to be sequential data. The second and third write units WD2 and WD3 having sizes smaller than the threshold value may be determined to be random data.

The CPU 224 may determine chunk values corresponding to each of sequential data and random data. A chunk value corresponding to random data is smaller than a chunk value corresponding to sequential data. The CPU 224 controls the compressing block 227 to compress sequential data and random data according to the determined chunk values.

The CPU 224 may control the compressing block 227 to compress the first write unit WD1 determined to be sequential data by the second chunk (chunk 2) unit. The CPU 224 may control the compressing block 227 to compress the second and third write units WD2 and WD3 determined to be random data by the first chunk (chunk 1) unit. A size of the first chunk (chunk 1) is smaller than a size of the second chunk (chunk 2). For example, a size of the second chunk (chunk 2) may be equal to the threshold value. A size of the first chunk (chunk 1) may be half the threshold value. Under the condition that a size of the first chunk (chunk 1) is smaller than a size of the second chunk (chunk 2), sizes of the first and second chunks (chunk1, chunk 2) may be varied.

In response to a control of the CPU 224, the compressing block 227 divides the first write unit WD1 by a second chunk unit (chunk 2). The first write unit WD1 is divided into write units WD1_1 and WD1_2. The write unit WD1_1 may constitute a first logical unit LU1. At this time, the write unit WD1_2 is smaller than a size of the second chunk (chunk 2) and thereby additional data AD1 may be added to the write unit WD1_2. The additional data AD1 may be constituted by logical values of specific pattern. The additional data AD1 may be constituted by same logical values (for example, everyone is “1” or “0”). The write unit WD1_2 and the additional data AD1 may constitute a second logical unit LU2.

In response to a control of the CPU 224, the compressing block 227 divides the second and third write units WD2 and WD3 by a first chunk unit (chunk 1). The second write unit WD2 and one part (WD3a) of the third write unit WD3 may constitute a third logical unit LU3. The other part (WD3b) of the third write unit WD3 is smaller than the first chunk 1. An additional data AD2 may be added to the other part (WD3b) of the third write unit WD3. The additional data AD2 may be constituted by logical values of specific pattern. The additional data AD2 may be constituted by same logical values. The other part (WD3b) of the third write unit WD3 and the additional data AD2 may constitute a fourth logical unit LU4.

The compressing block 227 may compress each logical unit. The first through fourth logical units LU1-LU4 are compressed to generate first through fourth compression units CU1-CU4. The generated compression units CU1-CU4 are temporally stored in the RAM 225 and the compressing block 227.

The CPU 224 generates first through fourth information CI1-CI4 corresponding to the compression units CU1-CU4 respectively. Each compression information includes information (i.e., chunk information corresponding to each compression unit) about a unit by which each compression unit is compressed. Each of the first and second compression information includes information about the second chunk (chunk 2). Each of the third and fourth compression information includes information about the first chunk (chunk 1).

Compression information may further include additional information. For example, the compression information may further include information (mark) notifying beginning data of compression unit and a length of compression unit.

According to another aspect of an exemplary embodiment, data received from the host is divided into sequential data and random data. The random data is compressed by a chunk unit smaller than the sequential data. Unlike the aspect described with reference to FIG. 7, the second and third write units WD2 and WD3 determined to be random data may also be compressed by the second chunk (chunk 2), and the second and third write units WD2 and WD3 may be compressed by one compression unit (fifth compression unit). If a read request for the second write unit WD2 is received from the host, the fifth compression unit is read from the storage unit 210. And then, the fifth compression unit is decompressed.

As described with respect to FIG. 7, if the second and third write units WD2 and WD3 are compressed by the first chunk (chunk 1), the second write unit WD2 and one part (WD3a) of the third write unit WD3 are compressed to the third compression unit CU3. If a read request for the second write unit WD2 is received from the host, the third compression unit CD3 is read from the storage media 210. The amount of data of the third compression unit CU3 is less than the amount of data of the fifth compression unit. The third compression unit CU3 is more rapidly read from the storage media 210 than the fifth compression unit. Also, the third compression unit CU3 is more rapidly decompressed than the fifth compression unit. An access speed on random data may be improved by compressing random data by a smaller unit than sequential data. According to an aspect of an exemplary embodiment, an operation speed of the data storage device 200 may be improved.

As data is compressed by a big chunk unit, compression efficiency (that is, the decrease in the amount of data to be stored in accordance with a compression) may be increased. Sequential data is compressed by a bigger chunk unit than random data. Compression efficiency of sequential data may be improved.

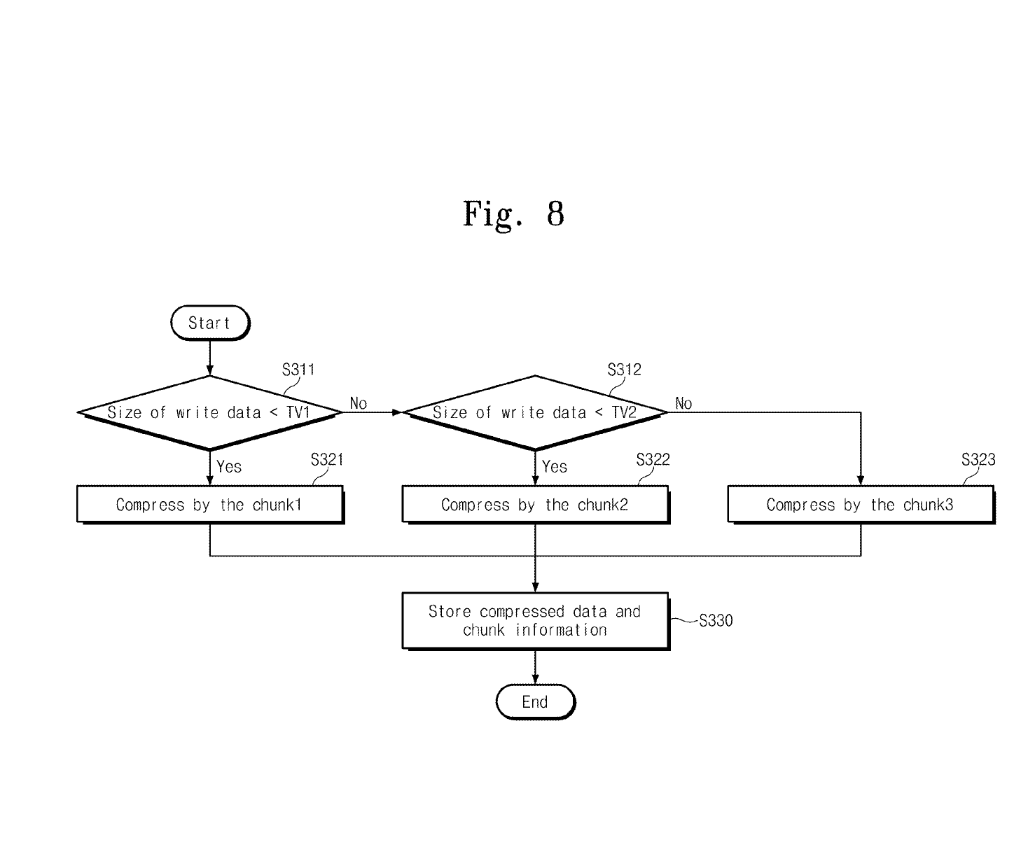

FIG. 8 is a flow chart showing another embodiment of steps of S130 and S140 of FIG. 4. A write method illustrated in FIG. 8 is the same as those described with reference to FIG. 6 except the following differences and description thereof is thus omitted.

In Step S311 and step S312, a write unit is determined to be one of plurality of groups. Unlike the aspect described with reference to FIG. 6, a write unit is not determined to be sequential data or random data but may be determined to be one of three or more groups. Each group is compressed by a chunk unit different from each other.

In the step S311, the CPU 224 compares a size of a write unit with a first threshold value (TV1). If the size of write unit is smaller than the first threshold value (TV1), step S321 is executed. If the size of write unit is equal to or greater than the first threshold value (TV1), the step S312 is executed.

In the step S312, the CPU 224 compares a size of write unit with a second threshold value (TV2). If the size of write unit is smaller than the second threshold value (TV2), step S322 is executed. If the size of write unit is equal to or greater than the second threshold value (TV2), the step S323 is executed.

In the step S321, the write unit is compressed by the first chunk unit (chunk 1). In the step S322, the write unit is compressed by the second chunk unit (chunk 2). In the step S323, the write unit is compressed by a third chunk unit (chunk 3). A size of the first chunk is smaller than a size of the second chunk. A size of the second chunk is smaller than a size of the third chunk.

A size of chunk corresponding to a write unit is determined according to a size of the write unit. As a size of write unit increases, a size of chunk corresponding to the write unit also increases. As a size of write unit decreases, a size of chunk corresponding to the write unit also decreases.

In step S330, the CPU 224 stores chunk information in the storage media 210 together with the compressed write unit. Since a compression operation is executed by one of the first through third chunk units, chunk information is stored in the storage media 210, which determines a chunk unit of compressed data when decompressing the data.

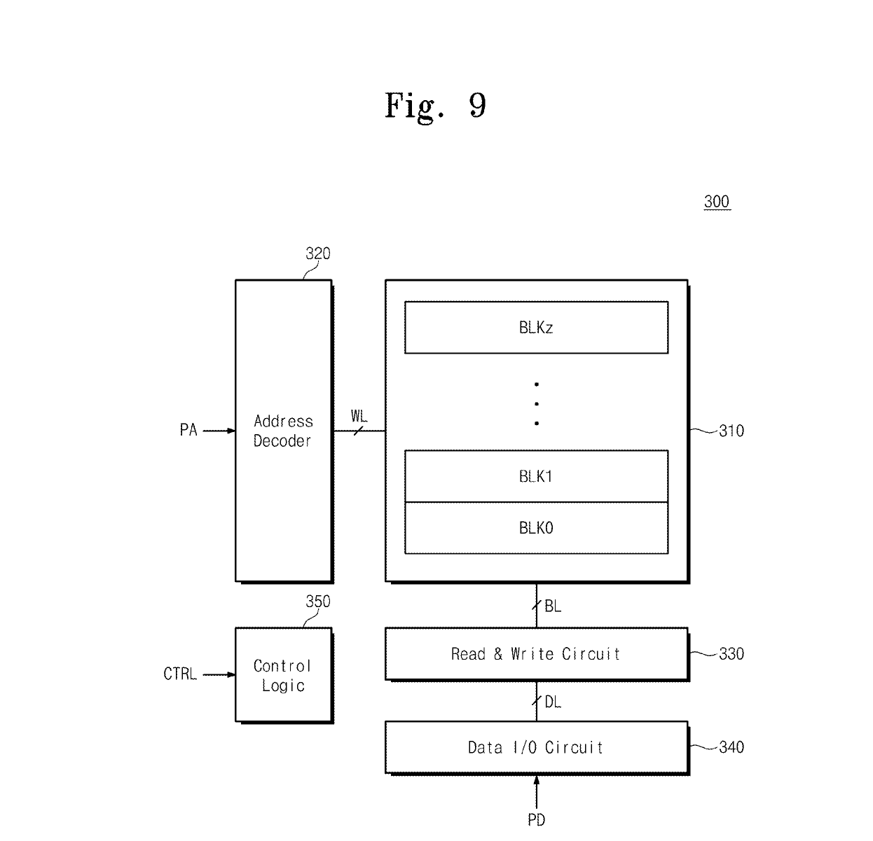

FIG. 9 is a block diagram showing a nonvolatile memory 300 as an embodiment of storage media 210 of FIG. 2. Referring to FIG. 2, the nonvolatile memory 300 includes a memory cell array 310, an address decoder 320, a read and write circuit 330, a data input/output circuit 340 and control logic 350.

The memory cell array 310 is connected to the address decoder 320 through word lines WL and connected to the read and write circuit 330 through bit lines BL. The memory cell array 310 includes a plurality of memory blocks BLK1-BLKz. Each of the memory blocks includes a plurality of memory cells. Memory cells of the memory cell array 310 arranged in a row direction are connected to the word lines WL. Memory cells of the memory cell array 310 arranged in a column direction are connected to the bit lines BL. Memory cells arranged in a column direction in each memory block constitute at least one page. A read operation and a program operation of the nonvolatile memory 300 are executed by a page unit. An erasure operation is executed by a memory block unit.

The address decoder 320 is configured to operate in response to a control of the control logic 350. The address decoder 320 receives a physical address PA from the control logic 350.

The address decoder 320 is configured to decode a block address among the physical address PA. According to the block address, at least one memory block is selected. The address decoder 320 is configured to decode a row address among the physical address PA. The address decoder 320 is configured to select a word line corresponding to the decoded row address. The address decoder 320 may select a line corresponding to the row address by applying different voltages to a selected word line and unselected word lines respectively.

The address decoder 320 is configured to decode a column address among the physical address PA. The address decoder 320 transfers the decoded column address to the read and write circuit 330.

The address decoder 320 may include a row decoder for decoding a row address, a column decoder for decoding a column address and an address buffer storing the physical address PA.

The read and write circuit 330 is connected to the memory cell array 310 through the bit lines BL. The read and write circuit 330 is connected to the data input/output circuit 340 through data lines DL.

The read and write circuit 330 operates in response to a control of the control logic 350. The read and write circuit 330 receives a decoded column address from the address decoder 320. In response to the decoded column address, the read and write circuit 340 selects a part or all of the bit lines BL.

The read and write circuit 330 receives processed data PA and writes the received data PA in the memory cell array 310. The processed data PA is data compressed by the controller 220 or raw data. The read and write circuit 330 reads data stored in the memory cell array 310 and outputs the data to the input/output circuit 340.

The read and write circuit 330 may include constituent elements such as a page buffer (or a page register), a column select circuit, a data buffer, etc. The read and write circuit 330 may include constituent elements such as a sense amplifier, a write driver, a column select circuit, a data buffer, etc.

The data input/output circuit 340 is connected to the read and write circuit 330 through the data lines DL. The data input/output circuit 340 operates in response to a control of the control logic 350. The data input/output circuit 340 receives processed data PD from the external host. The data input/output 340 is configured to transfer the processed data PD to the read and write circuit 330 through the data lines DL. The data input/output 340 is configured to output data received from the read and write circuit 330 through the data lines DL to the external host. The data input/output circuit 340 may include a data buffer.

The control logic 350 is connected to the address decoder 320, the read and write circuit 330 and the data input/output circuit 340. The control logic 350 is configured to control the whole operation of the nonvolatile memory 300 in response to a control signal CTRL received from the controller 220.

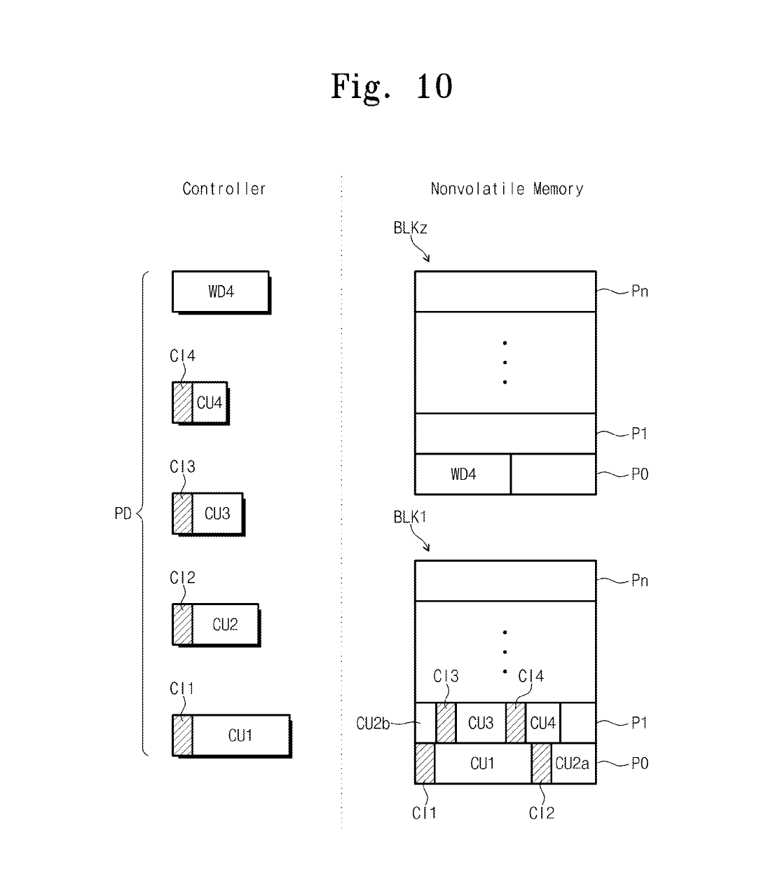

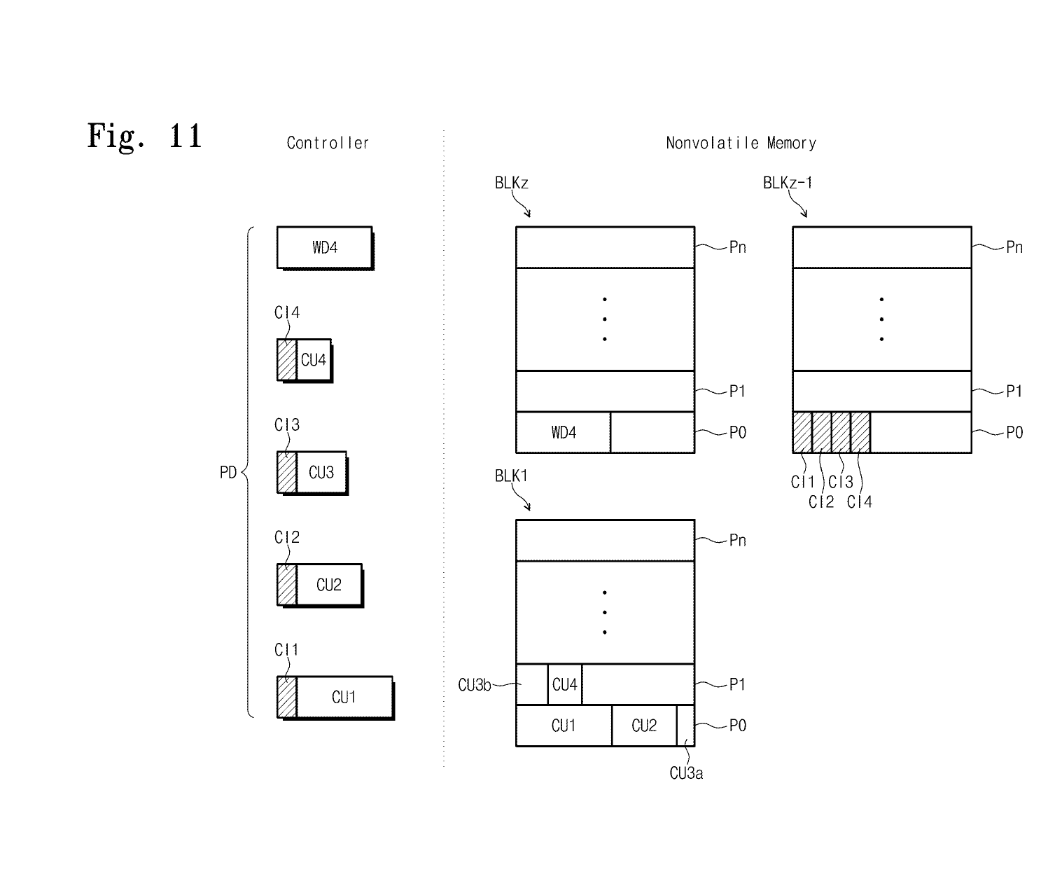

FIGS. 10 and 11 are drawings for describing a method of storing data PD processed by a controller 220 in a nonvolatile memory 300. Referring to FIGS. 7, 9 and 10, the processed data PD includes the raw fourth write unit WD4, the first through fourth compression units CU1-CU4 and the first through fourth compression information CI1-CI4.

Each memory block of the memory cell array 310 includes a plurality of pages P0-Pn. In FIG. 10, it is assumed that the first memory block BLK1 is an area in which user data is stored. It is assumed that the zth memory block BLKz is an area in which metadata is stored. However, this is only an illustration and user data and metadata may be stored in one memory block.

The fourth write unit WD4 is stored in page 0 (P0) of the zth memory block BLKz.

A compression unit and compression information corresponding to the compression unit may be stored in one memory block. Also, a compression unit and compression information corresponding to the compression unit may be stored in one page of one memory block.

The first through fourth compression units CU1-CU4 and the first through fourth compression information CI1-CI4 are stored in the first memory block BLK1. The first compression unit CU1 and the first compression information CI1 are stored in page 0 (P0) of the first memory block BLK1. One part (CU2a) of the second compression unit CU2 and the second compression information CI2 are stored in 0 page (P0) of the first memory block BLK1. The other part (CU2b) of the second compression unit CU2 is stored in 1 page (P1). The third compression unit CU3 and the third compression information CI3 are stored in 1 page (P1) of the first memory block BLK1. The fourth compression unit CU4 and the fourth compression information CI4 are stored in 1 page (P1) of the first memory block BLK1.

When a read request for stored compression unit is received from the host, the controller 220 controls the nonvolatile memory 300 to read compression information corresponding to a compression unit together with the compression unit. By operating a flash translation layer (FTL), the controller 220 generates a physical address PA corresponding to a logical address received together with a read request. The generated physical address PA corresponds to an area in which the requested compression unit and the compression information corresponding to the compression unit are stored. The compression unit and the compression information corresponding to the compression unit are read from the nonvolatile memory 300. The controller 220 receives compression unit and compression information from the nonvolatile memory 300. The compression information may include chunk information of the compression unit. The CPU 224 controls the compressing block 227 to decompress the compression unit according to the chunk information included in the compression information. The decompressed data may be provided to the host.

Unlike those described with reference to FIG. 10, a memory block in which the first through fourth compression units CU1-CU4 are stored may be different from a memory block in which the first through fourth compression information CI1-CI4 are stored. Referring to FIG. 11, the fourth write unit WD4 is stored in page 0 (P0) of the zth memory block BLKz.

The first and second compression units CU1 and CU2 and one part (CU3a) of the third compression unit CU3 are stored in page 0 (P0) of the first memory block BLK1. The other part (CU3b) of the third compression unit CU3 and the fourth compression unit CU4 are stored in 1 page (P1) of the first memory block BLK1.

The first through fourth compression information CI1-CI4 are stored in the z−1th memory block BLKz−1. The first through fourth compression information CI1-CI4 are stored in page 0 (P0) of the z−1th memory block BLKz−1.

When a read request for stored compression unit is received from the host, by operating a flash translation layer (FTL), the controller 220 controls the nonvolatile memory 300 to read compression information corresponding to a compression unit together with the compression unit.

Unlike those illustrated in FIGS. 10 and 11, one compression unit may not be divided to be stored in two pages (e.g., CU2a and CU2b of FIG. 10, CU3a and CU3b of FIG. 11) but may be stored in one page. According to that method, in the case that the nonvolatile memory 300 performs a read operation by a page unit, only one read operation is performed when a read operation is performed on one compression unit. Thus, an access speed to a compression unit may be improved.

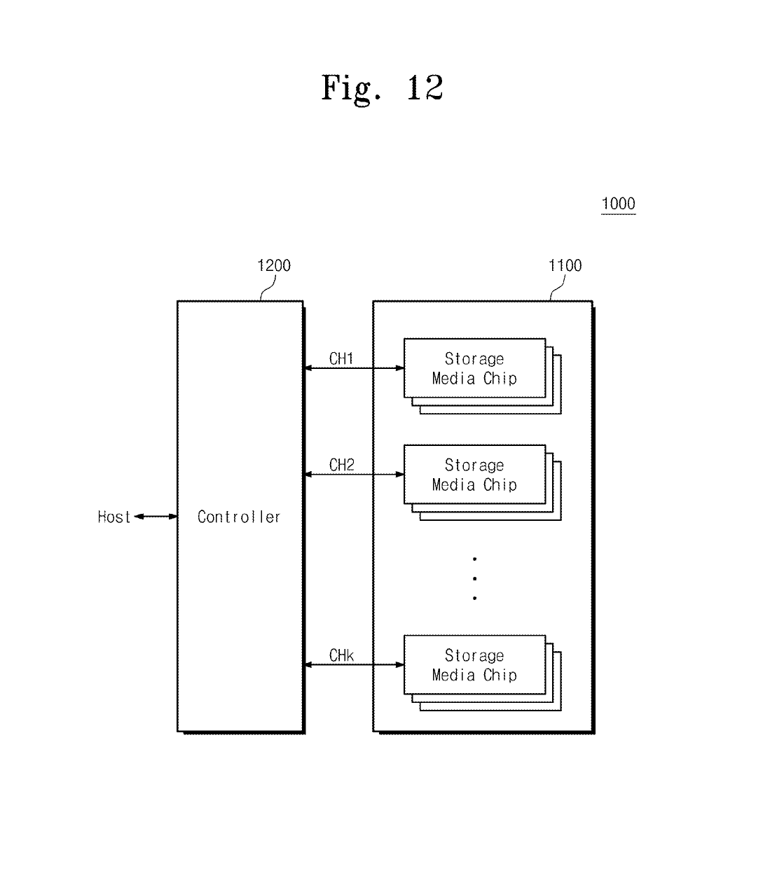

FIG. 12 is a block diagram showing an application example of data storage device 1000. Referring to FIG. 12, the data storage device 1000 includes a storage media 1100 and a controller 1200.

The storage media 1100 includes a plurality of storage media chips. The plurality of storage media chips is divided into a plurality of groups. Each of the groups of the storage media chips is configured to communicate with the controller 1200 through one common channel. The plurality of storage media chips are illustrated to communicate with the controller 1200 through first to kth channels CH1-CHk. Each of the charge media chips has the same structure as the nonvolatile memory 300 described with reference to FIG. 9 and may operate in the same manner as the nonvolatile memory 300. For example, each storage media chip may be configured to include 0 through zth memory blocks.

As described with reference to FIG. 3, the controller 1200 determines whether data received from a host is user data or metadata and compresses only user data. In the case that data received from the host is determined to be user data, the controller 1200 controls a size of chunk according to whether data received from the host is random data or sequential data. The controller 1200 stores compressed data (that is, compression units) and raw data in the storage media 1100. The controller 1200 may control the storage media 1100 to store the first through fourth compression units CU1-CU4 in different storage media chips. The controller 1200 may control the storage media 1100 to store the first through fourth compression units CU1-CU4 and the first through fourth compression information in different storage media chips.

The controller 1200 may manage a write operation, a read operation, and an erase operation of storage media chips connected to different channels.

In FIG. 12, a plurality of nonvolatile memory chips are connected to one channel. However, the memory system may be modified so that one nonvolatile memory is connected to one channel.

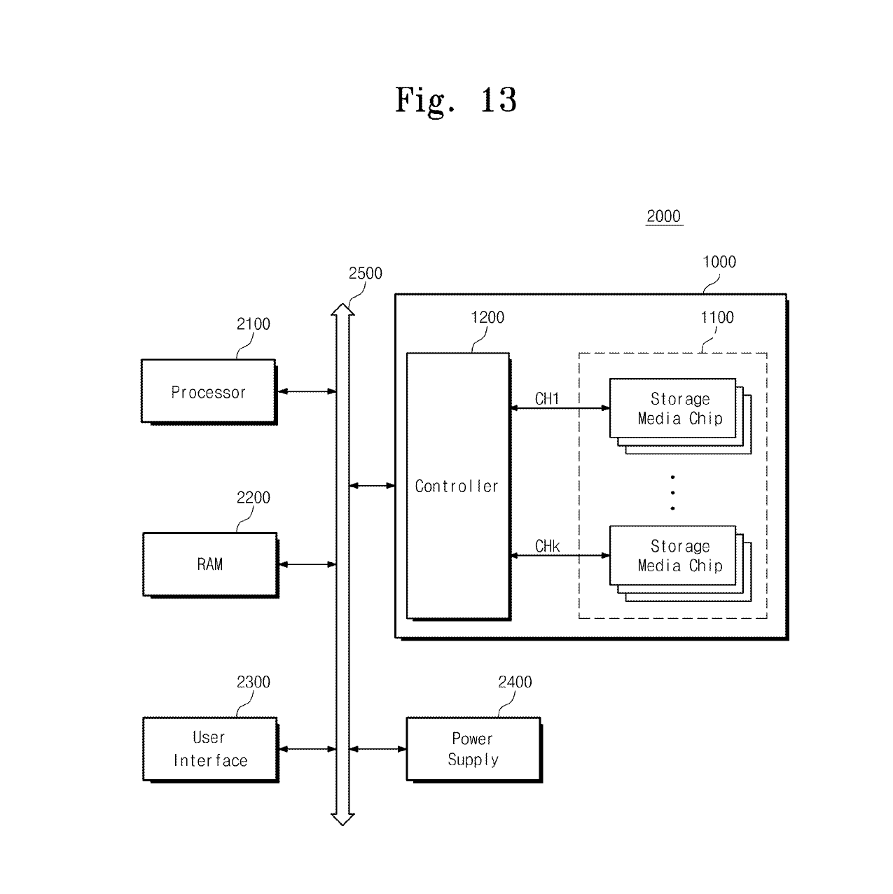

FIG. 13 is a block diagram showing a computing system 2000 including the data storage device 1000 described with reference to FIG. 12. Referring to FIG. 13, the computing system 2000 includes a processor 2100, a RAM 2200, a user interface 2300, a power supply 2400, a system bus 2500 and a data storage device 1000.

The data storage device 1000 is electrically connected to the processor 2100, the user interface 2300 and the power supply 2400 through the system bus 2500. Data provided through the user interface 2300 or processed by the processor 2100 is stored in the data storage device 1000.

In FIG. 13, the storage media 1100 is connected to the system bus 2500 through the controller 1200. However, the storage media 1100 may be configured to be directly connected to the system bus 2500. At this time, a function of the controller 1200 may be performed by the processor 2100 and the RAM 2200.

In FIG. 13, the data storage device 1000 described with reference to FIG. 12 is provided. However, the data storage device 1000 may be replaced with the data storage device 200 described with reference to FIG. 2.

The computing system 2000 may be configured to include the data storage devices (200, 1000) described with reference to FIGS. 2 and 12.

According to an aspect of an exemplary embodiment, the controller (220, 1200) determines whether data received from the host is metadata or user data and performs a compression operation on the user data. A compression operation is not performed on the metadata. An access speed to the metadata may be improved.

According to an aspect of an exemplary embodiment, the controller (220, 1200) determines whether user data is random data or sequential data and compresses the random data by a unit smaller than that of the sequential data. Thus, an access speed to the random data may be improved.

As a result, an operation speed of the host connected to the data storage device (200, 1000) may be improved.

According to an aspect of an exemplary embodiment, a controller selectively performs a compression operation according to whether data received from a host is user data or metadata.

According to an aspect of an exemplary embodiment, a controller determines whether user data is random data or sequential data and compresses the random data by a unit smaller than that of the sequential data. An access speed to the random data may be improved.

Thus, a data storage device effectively compressing data to be stored in a storage media and a method of writing data.

The above-disclosed subject matter is to be considered illustrative, and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A method of storing data in a storage medium comprising:
receiving data to be stored in the storage medium;
determining whether the received data is user data or metadata used to manage the user data;
determining whether to compress the received data according to a type of the determined data;
selectively compressing the received data according to the determination of whether to compress the received data; and
storing the selectively compressed data in the storage medium.

2. The method of claim 1, wherein the receiving the data comprises receiving a logical address, wherein the logical address indicates an area having sequential address values, and
wherein the selectively compressing the received data comprises:
determining a compression unit of data to be stored according to a size of an area indicated by the logical address when the data to be stored is determined to be the user data; and
compressing the data to be stored according to the determined compression unit.

3. The method of claim 2, wherein the determining the compression unit comprises:
comparing the size of the area indicated by the logical address with a threshold value to divide the data to be stored into random data and sequential data; and
selecting a compression unit of the data to be stored by a first chunk when the data to be stored is determined to be the random data and selecting a compression unit of the data to be stored by a second chunk greater than the first chunk when the data to be stored is determined to be sequential data.

4. The method of claim 1, wherein the receiving the data comprises storing write data and logical addresses received when a plurality of write operations are requested, and
wherein the write data comprises the data to be stored and logical addresses of areas which the logical addresses indicate have sequential address values.

5. The method of claim 4, wherein the selectively compressing the received data comprises:
determining compression units of the write data according to a size of an area which the logical address of the write data indicates when the write data is determined to be user data; and
compressing the write data by the determined compression units.

6. The method of claim 1, wherein the receiving the data comprises receiving a logical address together with the data to be stored in the storage media, and
wherein the determining whether the received data is user data or metadata used to manage the user data comprises determining the type of the received data according to the received logical address.

7. The method of claim 6, wherein the logical address is included in one of first and second groups and
wherein the determining the type of the received data according to the received logical address comprises:
determining that the received data is metadata used to manage the user data when the logical address is included in the first group; and
determining that the received data is user data when the logical address is included in the second group.

8. The method of claim 1, wherein the determining whether to compress the received data comprises making a determination to compress the received data when the received data is determined to be the user data, and
wherein the storing the selectively compressed data in the storage medium comprises storing the compressed received user data in the storage medium.

9. The method of claim 1, wherein determining whether to compress the received data comprises making a determination not to compress the received data when the received data is determined to be metadata used to manage the user data, and
wherein the storing the selectively compressed data in the storage medium comprises storing the received data determined to be metadata used to manage the user data uncompressed in the storage medium.

10. A data storage device comprising:
a storage medium; and
a controller configured to selectively compress received data and store the selectively compressed data in the storage medium,
wherein the controller is configured to determine whether the received data is user data or metadata used to manage the user data and selectively compress the received data according to the determined type.

11. The data storage device of claim 10, wherein the controller is configured to receive a logical address corresponding to the received data and determine a type of the received data according to the received logical address,
wherein when the received data is determined to be the user data, the received data is compressed and the compressed data is stored in the storage medium, and
wherein when the received data is determined to be the metadata used to manage the user data, the received data is stored in the storage medium without a compression operation.

12. The data storage device of claim 10, wherein the controller receives a logical address corresponding to the received data,
wherein the logical address indicates an area having sequential address values, and
wherein if the received data is determined to be user data, the controller is configured to determine a compression unit of the received data according to a size of an area which the logical address indicates and then compress the received data by the determined compression unit.

13. The data storage device of claim 12, wherein the controller is configured to store information about the determined compression unit together with the compressed data in the storage medium.

14. The data storage device of claim 13, wherein the storage medium is a nonvolatile memory including a plurality of memory blocks,
wherein each of the plurality of memory blocks comprises a plurality of pages, and
wherein information about compression unit corresponding to the compressed data is stored in a page in which the compressed data is stored.

15. The data storage device of claim 13, wherein the storage medium is a nonvolatile memory including a plurality of memory blocks, and
wherein information about the determined compression units is stored in one of the plurality of memory blocks except a memory block in which the compressed data is stored among the plurality of memory blocks.

16. The data storage device of claim 13, wherein in response to a read request for the stored compressed data, the controller is configured to read information about the compression unit corresponding to the compressed data and the compressed data from the storage medium and perform a decompression operation on the basis of the read information about the compression unit.

17. A data storage device comprising:
a controller configured to selectively compress received data and store the selectively compressed data in a storage medium,
a host interface which performs a data exchange between a host and the controller,
wherein the controller is configured to determine whether the received data is user data or metadata used to manage the user data and compress the received data if it is determined that the received data is user data.

18. The data storage device of claim 17, wherein the controller receives a logical address having sequential address values corresponding to the received data, and
wherein when the received data is determined to be user data, the controller is configured to determine a compression unit of the received data according to a size of an area indicated by the logical address and compress the received data by the determined compression unit.

19. The data storage device of claim 18, wherein the controller is configured to store compression unit information with the compressed data in the storage medium.

20. The data storage device of claim 17, wherein the user data comprises text, image data, voice data, or software data.
